(19) United States
(12) Patent Application Publication
(10) Pub. No.: US 2005/0244126 A1
(43) Pub. Date: Nov. 3, 2005

(54) Light guides and method of forming same

(75) Inventors: P. Guy Howard, Junction City, OR (US); Kevin Hulick, Corvallis, OR (US); Michael Long, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD CO.

(21) Appl. No.: 10/837,425

(22) Filed: Apr. 30, 2004

(51) Int. Cl. G02B 6/00

(52) U.S. Cl. 385/133

(57) ABSTRACT

Guides, such as light guides, optical devices including such guides and methods of forming the guides are disclosed. The guide includes a plurality of plates positioned to form a tunnel. Each of the plates has an internal surface with first and second opposing ends, and a side edge along the first opposing end. The side edge along the first opposing end of each plate abuts an internal surface of a first adjacent plate, and the internal surface of each plate is abutted by a side edge of a second adjacent plate.

### BACKGROUND OF THE INVENTION

Optical devices, such as digital projectors include numerous components to process light from a light source to, for example, a screen. One of these components is a light guide, also referred to in the art as integrated rod or a spatial homogenizer.

Light guides include a hollow tunnel, with the internal walls being highly reflective. The light from a light source is typically not uniform. For example, the intensity of the light may be significantly greater at the center of the beam than at the perimeter. To correct for this non-uniformity, a light guide is positioned in the light path between the source and an image processing portion. Thus, the light exiting the guide has a substantially homogeneous cross-section and is delivered to the image processing portion.

The cross-section of the light exiting the guide in various designs is dimensioned to correspond to the desired aspect ratio of the final image. For example, certain media formats require an aspect ratio of 16:9. For such cases, the cross-section of the light exiting the guide must also have an aspect ratio of 16:9. In order to achieve this, light guides are generally designed to have very precise dimensions.

FIG. 1 illustrates a typical light guide 10. The light guide 10 is fabricated by arranging four plates 11-14 in a rectangular pattern, with the plates forming an internal tunnel 16 having a depth d and a width w. The tunnel 16 is formed by placing two vertical plates 13, 14 within the planes of the internal surfaces of the two horizontal plates 11, 12. In order to achieve the precise dimensions of the tunnel 16, the vertical plates 13, 14 are precisely fabricated to match the desired depth d of the tunnel 16. Further, both edges of the vertical plates abutting the horizontal plates are precisely fabricated to provide an acceptable joining of the plates.

FIG. 2 illustrates another prior art light guide 20 having a tunnel 26 with a depth d and a width w. In this configuration, the light guide 20 includes two vertical plates 23, 24 and two horizontal plates 21, 22 forming the tunnel 26. Each end of each horizontal plate 21, 22 is provided with a notch 28 for receiving the ends of the vertical plates 23, 24. The notches 28 have dimensions, including notch depth z, selected to achieve the desired tunnel dimensions d, w. As with the configuration illustrated in FIG. 1, the light guide 20 of FIG. 2 uses precise manufacturing of the plates 21-24 to achieve the desired dimensions d, w. Moreover, precise fabrication of the notches 28 can be a complicated and expensive process.

### SUMMARY OF THE INVENTION

One embodiment of the invention relates to a guide, such as a light guide. The guide includes a plurality of plates positioned to form a tunnel. Each of the plates has a reflective internal surface with first and second opposing ends, and a side edge along the first opposing end. The side edge along the first opposing end of each plate abuts an internal surface of a first adjacent plate, and the internal surface of each plate is abutted by a side edge of a second adjacent plate.

It is to be understood that both the foregoing general description and the following detailed description are exemplary and exemplary only, and are not restrictive of the invention as claimed.

### BRIEF DESCRIPTION OF THE DRAWINGS

FIG. 1 is a perspective view of a prior-art light guide;

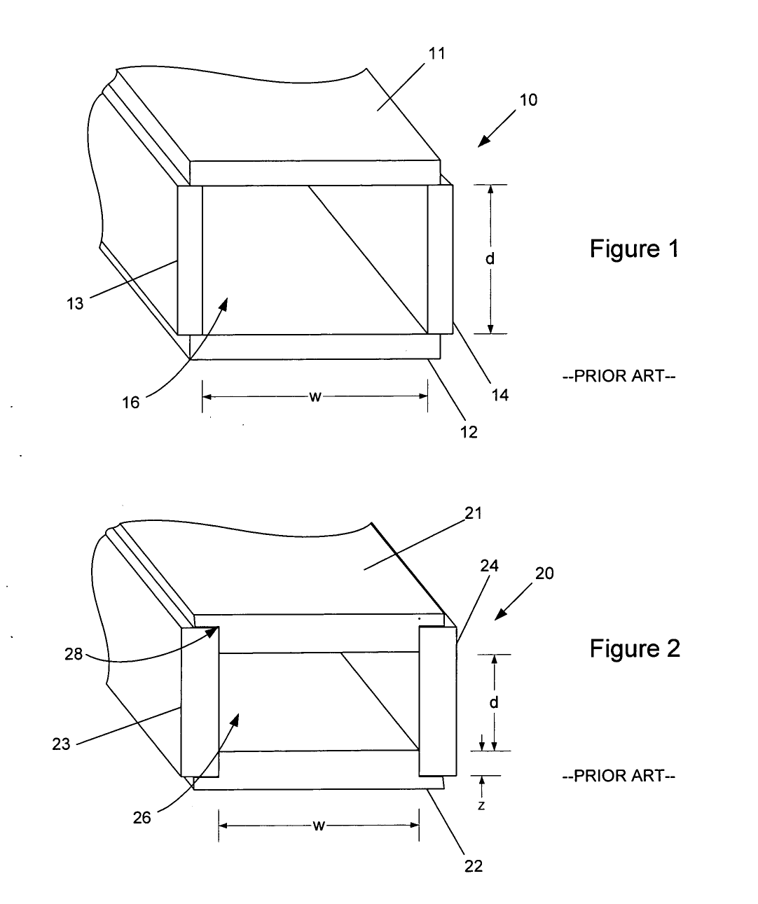

FIG. 2 is a perspective view of another prior-art light guide;

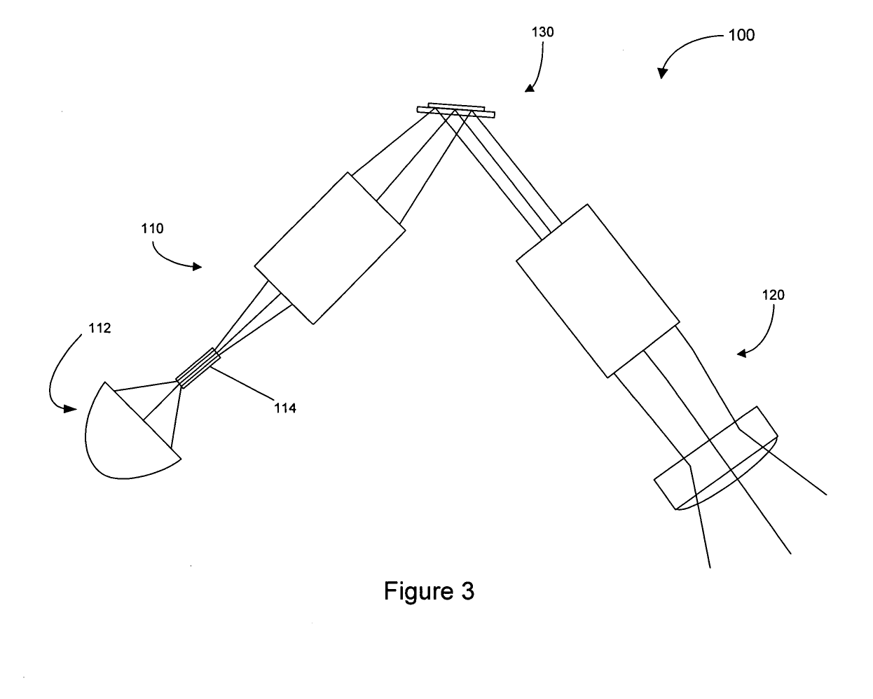

FIG. 3 is a schematic illustration of an optical device;

FIG. 4 is a perspective view of a light guide according to an embodiment of the invention;

FIG. 5 is a top plan view of an embodiment of an apparatus for forming the light guide of FIG. 4; and

FIGS. 6A-D illustrate a method for making the light guide of FIG. 4 using the tool illustrated in FIG. 5.

In the figures, like numerals are used to represent like elements.

### DETAILED DESCRIPTION OF CERTAIN EMBODIMENTS

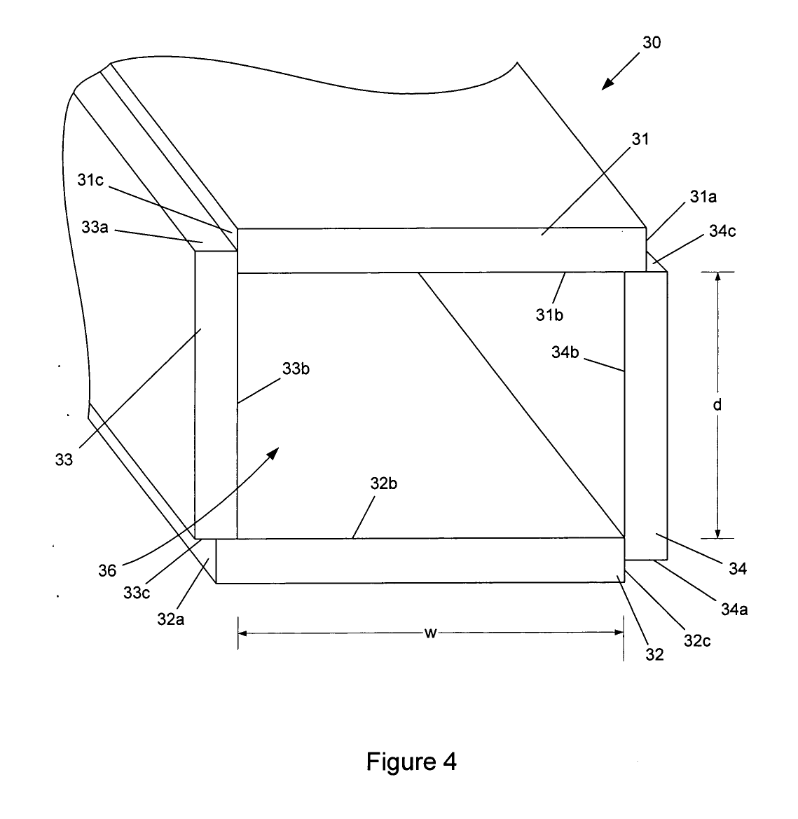

FIG. 3 schematically illustrates a digital projector according to one embodiment. The digital projector 100 includes an illumination portion 110, a projection portion 120 and an image processing portion 130. The illumination portion 110 includes a light source 112 and may include other components to direct the light to the image processing portion 130, which may include a digital micromirror device (DMD) or a diffractive light device (DLD) for processing the image. The processed image is then directed from the image processing portion 130 through the projection portion 120 to, for example, a screen (not shown). The projection portion 120 may also include one or more lenses to direct and/or focus the image onto the screen.

Light from the light source 112 is passed through a light guide 114. Light guides are also known in the art as light homogenizers, a spatial homogenizers or integrated rods. The light guide 114 outputs a substantially homogeneous beam of light for delivery to the image processing portion 130.

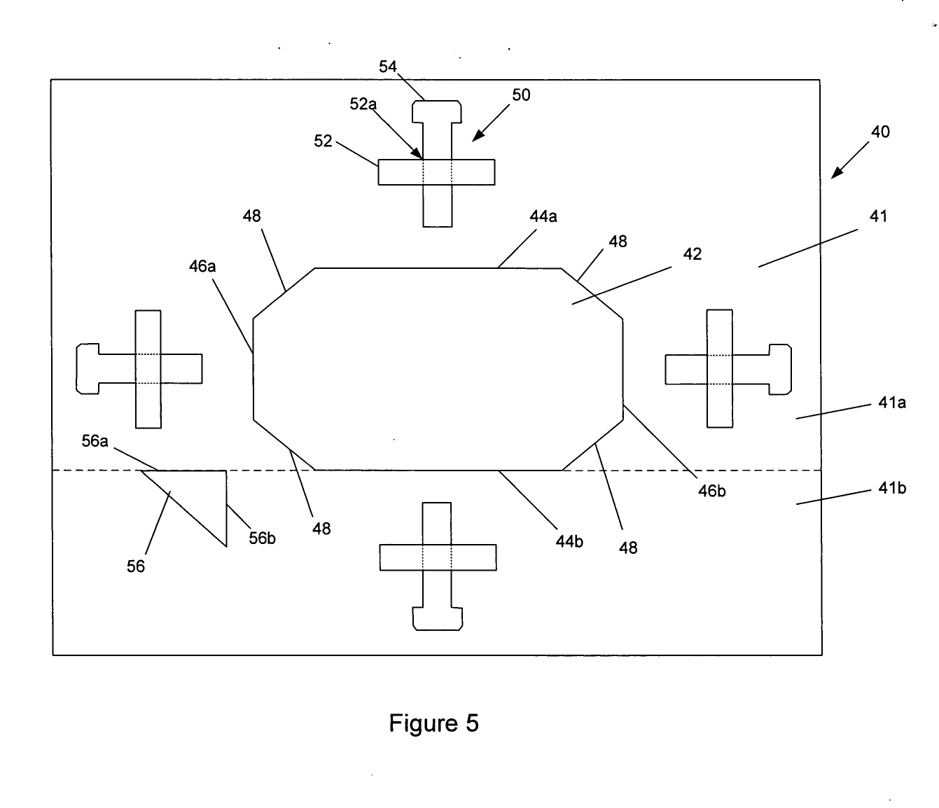

Referring to FIG. 4, a perspective view of a light guide according to one embodiment is illustrated. The light guide 30 includes a plurality of plates positioned to form a tunnel 36. In the illustrated embodiment, the plates include two horizontal plates 31, 32 and two vertical plates 33, 34 forming the tunnel 36. The tunnel is rectangular and has a depth d and a width w to correspond with a desired aspect ratio for the light exiting the guide 30. The plates 31-34 may be formed of a variety of materials, such as glass or aluminum.

Each of the plates has an internal surface 31b, 32b, 33b, 34b, respectively, with first and second opposing ends. The internal surfaces 31b, 32b, 33b, 34b of each plate 31, 32, 33, 34, respectively, are formed to be highly reflective. In a particular embodiment, the internal surfaces are provided with a dielectric mirror or reflective coating. Thus, light entering the guide 30 can strike the walls of the tunnel 36 and be reflected as it travels through the tunnel 36 with minimal loss of intensity.

Each of the plates 31-34 has side edges (31a, 31c, etc.) along the opposing ends. In the exemplary embodiment of FIG. 4, each plate 31-34 of the light guide 30 is substantially flat with a thickness selected to provide sufficient strength and durability for the light guide 30. In the illustrated embodiment, the thickness provides each plate with a substantially rectangular cross-section. For example, the top horizontal plate 31 has a cross-section including the flat internal surface 31b and side edges 31a, 31c.

The light guide 30 is formed by arranging the plates 31-34 such that one side edge of each plate abuts an internal surface of one adjacent plate, and a side edge of another adjacent plate abuts the internal surface of the plate. Thus, the left side edge 31c of the top plate 31 abuts the internal surface 33b of the adjacent left vertical plate 33, while the edge 34c of the adjacent right vertical plate 34 abuts the internal surface 31b of the top plate 31. Each of the other plates 32-34 forming the light guide 30 is similarly situated between two adjacent plates.

In this configuration, each plate 31-34 is not required to be dimensioned with great precision, thereby reducing the cost of fabricating the plates. As can be seen in the illustration of FIG. 4, each plate, such as the top plate 31, has one end which extends over the side edge of another plate, such as the side edge 34c of the right vertical plate 34. Thus, any imprecision in the fabrication of the plate is mitigated by this extension. Only the side edge of each plate abutting an internal surface of another plate may require precise fabrication. For example, the side edge 31c of the top plate 31 abutting the internal surface 33b of the left vertical plate 33 may be required to be precisely fabricated to assure a good joining of the adjacent plates 31, 33.

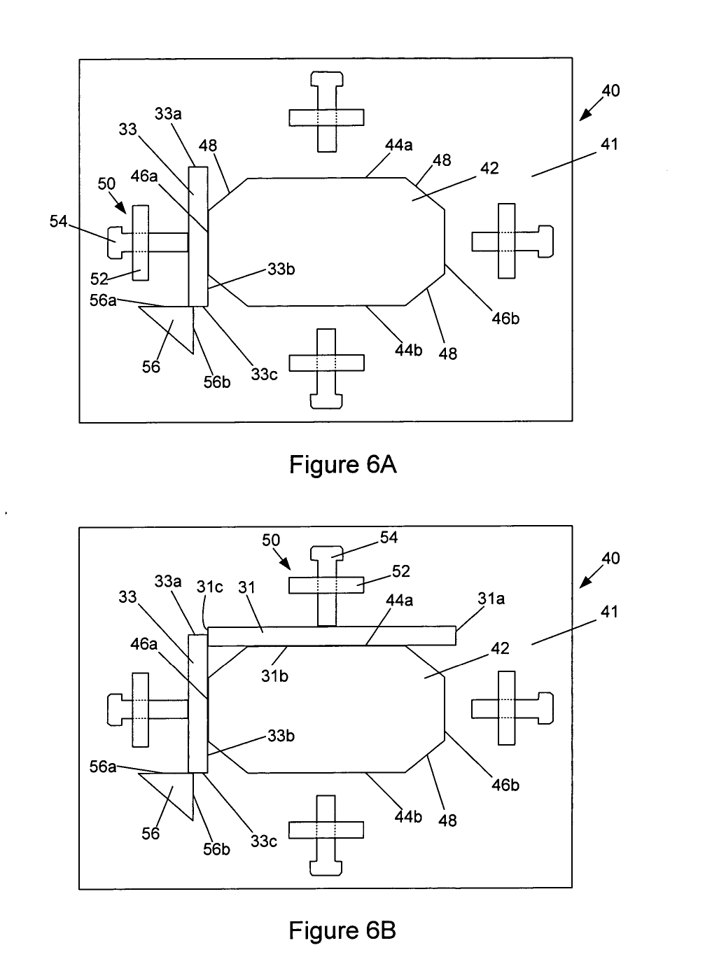

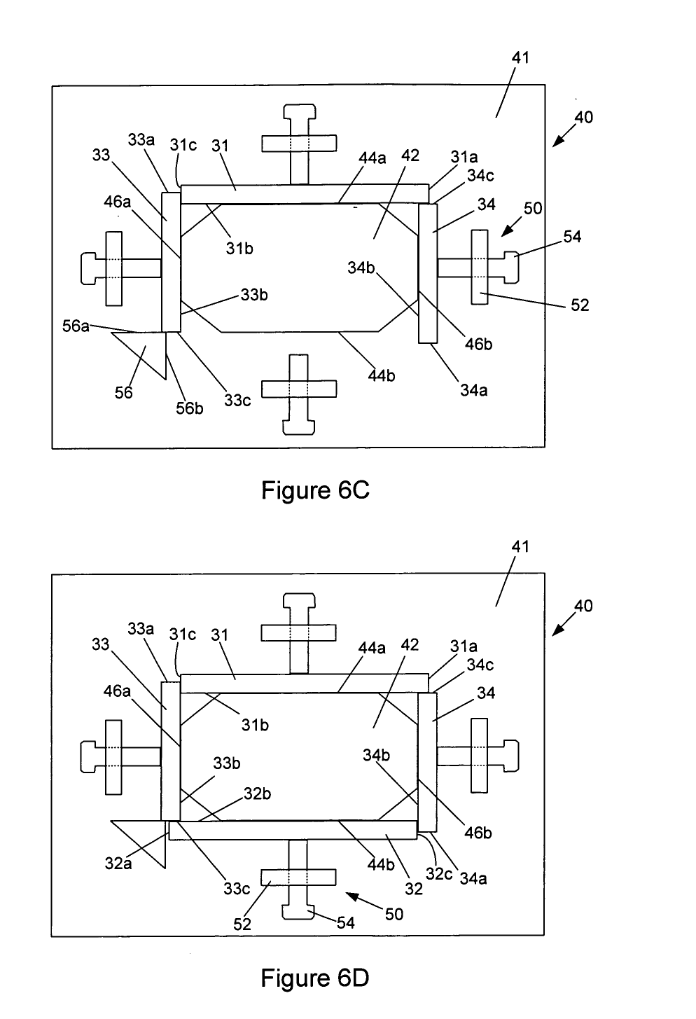

Referring now to FIG. 5, an embodiment of an apparatus for forming a light guide, such as the light guide 30 illustrated in FIG. 4, is illustrated. The process of forming the light guide 30 using the apparatus of FIG. 5 is described below with reference to FIGS. 6A-D. The apparatus 40 includes a base 41 upon which other components of the apparatus 40 are disposed. The base 40 may be any rigid, flat surface adapted to support the apparatus components and the plates forming the light guide.

A central block 42 is disposed on the base 41 and serves as a template for the light guide to be formed. The central block 42 is raised from the surface of the base 41 sufficiently to support the plates used to form the light guide 30 and includes walls to position the plates according to the desired aspect ratio. Thus, the formation of the block should be sufficiently precise to satisfy the requirements of the final product (e.g., the light guide, digital projector, etc.).

In particular, the four walls of the central block 42 should be dimensioned to correspond to the dimensions of the light guide. In this regard, the central block 42 includes top wall 44a, bottom wall 44b, left wall 46a, and right wall 46b. Adjacent walls are separated by a corner cutaway 48 which may facilitate assembly of the light guide.

A plate securing arrangement 50 is provided across from each wall 44a, 44b, 46a, 46b of the central block 42 for positioning and securing a plate of a light guide against the wall of the central block 42. In the illustrated embodiment, each plate securing arrangement 50 includes a rigid support 52 fixedly attached to the base 40 and in a fixed position relative to the central block 42. The plate securing arrangement 50 of the illustrated embodiment also includes a fastener 54 projecting through a hole 52a in the rigid support 52. The fastener 54 is adapted to be selectively moved forward or backward to secure or release a plate against a wall of the central block 42. The fastener 54 and the through hole 52a may be correspondingly threaded to facilitate the selective movement.

An initial positioning support 56 is provided fixedly positioned on the base 41 to facilitate positioning of the first plate in the formation of the light guide. While the walls of the central block 42 and the plate securing arrangement 50 facilitate proper positioning of an internal surface of a plate, the initial positioning support 56 forms a guide for the proper positioning of a side edge of the first plate to be positioned during the light-guide formation process. In this regard, the initial positioning support 56 of the illustrated embodiment includes a positioning surface 56a. The positioning surface 56a is adapted to position a side edge of a plate on the left wall 46a such that the side edge is aligned with the plane of the bottom wall 44b. Thus, in the illustrated embodiment, the positioning surface 56a is formed as a flat surface aligned with the plane of the bottom wall 44b.

The initial positioning support 56 of the illustrated embodiment is formed in a triangular shape. Of course, those skilled in the art will recognize that many other shapes are possible to provide a positioning surface 56a for aligning a plate edge with the bottom wall 44b. In the illustrated embodiment, while one leg of the triangle forms the positioning surface 56a, the other leg forms a surface 56b that is offset from the plane of the left wall 46a. As illustrated below in FIG. 6D, the offset allows for positioning of the final plate of the light guide while allowing form imprecision in the dimension of the plate. It is noted that the form of the initial positioning support 56 of FIG. 5 is illustrated for exemplary purposes only. Many other forms are possible and are contemplated within the scope of the invention. For example, in other embodiments, the initial positioning support may simply be a mark or one or more pins to guide the positioning of the side edge.

As noted above, the positioning surface 56a of the initial positioning support 56 is aligned with the bottom surface 44b of the central block 42. In a particular embodiment, this alignment is facilitated by forming the apparatus 40 in two segments. In this regard, the base 41 is divided into two separate sections 41a, 41b. The separation of the two sections 41a, 41b is indicated by the dashed line in FIG. 5. The central block can be positioned on the first section 41a of the base 41 such that the bottom wall 44b lies on an edge of the base. Similarly, the initial positioning support 56 can be placed such that the positioning surface 56a lies on an edge of the second section 41b of the base. Thus, when the two sections 41a, 41b of the base 41 are joined, as shown in FIG. 5, the bottom wall 44b of the central block 42 and the positioning surface 56a of the initial positioning support 56 are aligned.

The formation of an exemplary light guide using the apparatus illustrated in FIG. 5 will now be described with reference to FIGS. 6A-D. Referring first to FIG. 6A, a first plate (left plate 33) is positioned with its internal surface 33b facing the left wall 46a of the central block 42. The left plate 33 has side edges 33a, 33c along the ends of the internal surface 33b. A side edge 33c of the left plate 33 is positioned to abut the positioning surface 56a of the initial positioning support 56. With the side edge 33c abutting the positioning surface 56a, the fastener 54 of the plate securing arrangement 50 opposite the left wall 46a is moved forward to position the internal surface 33b of the plate 33 against the left wall 46a. The left plate 33 may be secured in this position by the fastener 54.

Next, as shown in FIG. 6B, a second plate (top plate 31 with side edges 31a, 31c and internal surface 33b) of the light guide can be positioned against the top wall 44a. In this regard, the internal surface 33b of the secured left plate 33 is used to properly position a side edge 31c of the top plate 31. The fastener 54 of the plate securing arrangement 50 opposite the top wall 44a is moved forward to position and secure the internal surface 31b of the plate 31 against the top wall 44a.

The third plate (right plate 34 with side edges 34a, 34c and internal surface 34b) is similarly positioned against the right wall 46b, as shown in FIG. 6C. The internal surface 31b of the top plate 31 is used to properly position a side edge 34c of the right plate 34.

Referring now to FIG. 6D, the fourth and final plate (bottom plate 32 with side edges 32a, 32c and internal surface 32b) of the light guide is positioned against the bottom wall 44b of the central block 42. The internal surface 34b of the right plate 34 is used to properly position the side edge 32c of the bottom plate 32. The fastener 54 of the plate securing arrangement 50 opposite the bottom wall 44b is moved forward to position and secure the internal surface 32b of the plate 32 against the bottom wall 44b.

In certain embodiments, the initial positioning support 56 may be eliminated. In these embodiments, the first plate (e.g., the left plate 33) may be positioned against the left wall 46a in a position that allows the top plate 31 to abut the internal surface 33b. When the fourth plate (bottom plate 32) is positioned against the bottom wall 44b and abutting the internal surface 34b of the right plate 34, the first plate 33 may be released by the plate securing arrangement and allowed to slide until the side edge 33c abuts the internal surface 32b of the bottom plate 32.

With the plates 31-34 secured in place by the plate securing arrangements 50, an adhesive may be applied to external corners at the junction of adjacent plates to complete the light-guide formation.

It is noted that the figures and description above refer to light guides and the formation of light guides having a rectangular cross section. It will be understood by those skilled in the art that light guides having any other cross-sectional configuration may also be similarly provided. All such configurations are contemplated within the scope of the invention.

The foregoing description of embodiments of the invention have been presented for purposes of illustration and description. It is not intended to be exhaustive or to limit the invention to the precise form disclosed, and modifications and variation are possible in light of the above teachings or may be acquired from practice of the invention. The embodiment was chosen and described in order to explain the principles of the invention and its practical application to enable one skilled in the art to utilize the invention in various embodiments and with various modification as are suited to the particular use contemplated. It is intended that the scope of the invention be defined by the claims appended hereto and their equivalents.

1. A light guide for outputting spatially homogenized light, comprising:
a plurality of plates positioned to form a tunnel, each of said plates having a reflective internal surface with first and second opposing ends, each of said plates further having a side edge along the first opposing end;
wherein said side edge along the first opposing end of each plate abuts an internal surface of a first adjacent plate, and the internal surface of each plate is abutted by a side edge of a second adjacent plate.

2. The guide according to claim 1, wherein the plurality of plates includes four plates positioned to form a rectangular tunnel.

3. The guide according to claim 1, wherein each of the plurality of plates is formed of glass or aluminum.

4. The guide according to claim 1, wherein the internal surface of each of said plates includes a dielectric mirror coating.

5. The guide according to claim 1, wherein each of said plates has a rectangular cross section.

6. An optical device, comprising:
a light guide adapted to output spatially homogenized light, the guide having a plurality of plates positioned to form a tunnel, each of said plates having a reflective internal surface with first and second opposing ends, each of said plates further having a side edge along the first opposing end;
wherein said side edge along the first opposing end of each plate abuts an internal surface of a first adjacent plate, and the internal surface of each plate is abutted by a side edge of a second adjacent plate.

7. The optical device according to claim 6, wherein said optical device is a digital projector.

8. The optical device according to claim 7, wherein the plurality of plates includes four plates positioned to form a rectangular tunnel, said tunnel being dimensioned according to a desired aspect ratio of said digital projector.

9. The optical device according to claim 6, wherein the plurality of plates includes four plates positioned to form a rectangular tunnel.

10. The optical device according to claim 6, wherein each of the plurality of plates is formed of glass or aluminum.

11. The optical device according to claim 6, wherein the internal surface of each of said plates includes a dielectric mirror coating.

12. The optical device according to claim 6, wherein each of said plates has a rectangular cross section.

13. A method of forming a guide for outputting spatially homogenized light, comprising:
a) positioning a plate to form a portion of said guide, said plate having a reflective internal surface and a side edge;
b) positioning a next plate having a reflective internal surface and a side edge to form a portion of said guide, said side edge of said next plate abutting said internal surface of a previously positioned plate;
c) repeating step b) until said plates form a tunnel with said reflective internal surfaces of said plates;
wherein a reflective internal surface of a last plate is abutted by said side edge of said plate positioned in step a).

14. The method according to claim 13, wherein step a) includes positioning said side edge of said plate at a predetermined location.

15. The method according to claim 13, wherein said plate positioned in step a) is repositioned after step c) so that said side edge of said plate positioned in step a) abuts said internal surface of said last plate.

16. The method according to claim 13, wherein said plates are formed of glass or aluminum.

17. The method according to claim 13, wherein the internal surface of each of said plates includes a dielectric mirror coating.

18. A light guide for outputting spatially homogenized light, comprising:
a plurality of means for forming a tunnel, each of said plurality of means including:
means for reflecting light within said tunnel;
means for abutting means for reflecting light of an adjacent means for forming a tunnel; and
means for receiving a means for abutting of a second adjacent means for forming a tunnel.

19. An apparatus for forming a light guide for outputting spatially homogenized light, comprising:
a central block having side walls, each of said side walls adapted to receive a reflective internal surface of a plate to form a tunnel; and
a plurality of plate securing arrangements, each of said arrangements being positioned opposite one of said side walls and being adapted to secure a plate with a reflective internal surface against a side wall.

20. The apparatus according to claim 19, further comprising:
an initial positioning support having a positioning guide, said positioning guide being aligned with a plane of one of said side walls.

21. The apparatus according to claim 20, further comprising:
a base having said central block and said initial positioning support mounted thereon.

22. The apparatus according to claim 20, wherein said base includes a first section and a second section, one of said side walls of said central block being positioned on an edge of said first section, and said positioning guide of said initial positioning support being positioned on an edge of said second portion.
